(19) United States
(12) Patent Application Publication
(10) Pub. No.: US 2026/0220469 A1
(43) Pub. Date: Jul. 30, 2026

(54) EVOLUTIONARY-BASED LLM EVALUATION FRAMEWORK GUIDED BY HUMAN FEEDBACK TO ADAPT NEURAL METRICS TO BE MORE RELIABLE FOR SPECIFIC DOMAINS

(71) Applicant: Dell Products L.P., Round Rock, TX (US)

(72) Inventors: Jonathan Mendes De Almeida, Brasília (BR); Luiz Fernando Sommaggio Coletta, Rio Claro (BR); Micael Veríssimo de Araújo, Rio de Janeiro (BR); Pablo Nascimento da Silva, Niterói (BR)

(21) Appl. No.: 19/036,850

(22) Filed: Jan. 24, 2025

(51) Int. Cl. G06N 3/086; G06F 11/34

(52) U.S. Cl. CPC G06N 3/086; G06F 11/3409

(57) ABSTRACT

One example method includes receiving, as input, a basket of questions from a domain, LLM-generated answers to each of the questions, and a respective human-generated score for each of the LLM-generated answers, obtaining respective fitness measurements, based on the input, for each neural metric in a population of neural metrics usable to evaluate a performance of the LLM when responding to a user inquiry, using, by an evolutionary algorithm, the fitness measurements to generate evolved neural metrics based on the neural metrics for the domain of interest, and generating the evolved neural metrics comprises generating a respective new version for one or more of the neural metrics for the domain of interest, and outputting a ranking of the evolved neural metrics according to a respective quality of each of the evolved neural metrics.

### COPYRIGHT AND MASK WORK NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyrights whatsoever.

### TECHNOLOGICAL FIELD OF THE DISCLOSURE

Embodiments disclosed herein generally relate to LLMs (large language models). More particularly, at least some embodiments relate to systems, hardware, software, computer-readable media, and methods, for evaluation of LLM performance.

### BACKGROUND

Chatbots driven by generative models built on Large Language Models (LLMs) continue to astound with their capabilities in an ever-increasing array of human knowledge domains. By successfully tackling different tasks in the realm of Natural Language Processing (NLP), they prove to be versatile solutions for companies and corporations, not only improving internal processes, but also providing useful tools for their customers and partners. Contrasting with traditional systems, which can only output a pre-defined limited set of answers to a user query, LLMs can smartly leverage text generation, summarization, completion, and translation, proving to be the state-of-the-art in the creation of dialog/conversational agents.

Although researchers are making strides in LLM tasks, one of the most challenging aspects, known as Open-Domain Question Answering (ODQA), still has many points of concern that need to be addressed. One is how LLMs can be evaluated and how metrics for evaluation can be effectively utilized for this. The difficulty in the ODQA context is that there is not, for the most of possible questions posed to LLMs, a single fixed ground-truth answer whose model response can approximate, as a target. Instead, there are typically an indefinite number of acceptable open-ended answers for a wide spectrum of subjects, with which model answers can be compared to finally extract scores to measure LLM/chatbot performance.

Recently, neural-based learned metrics, such as BERTScore, BLEURT, and COMET, have demonstrated a superior ability to be aware of semantic nuances during LLMs evaluation compared to conventional lexical-based metrics. This means that neural metrics are more likely to understand synonyms and paraphrases when scoring the quality of a model responses against a reference answer, thus leading to a more reliable evaluation in the context of ODQA. This fact has led the scientific community, companies, and organizations to increasingly adopt these metrics for LLMs evaluation. However, because these metrics are trained, they suffer from the same problems found in non-deterministic data-driven models. For example, the dependence on the quality of the training data, difficulties in configuring hyperparameters causing under/overfitting and ineffective training, can lead to biases, low generalization capacity and so on. As a result, these metrics can distort the calculated scores, hindering evaluations of the LLM performance.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings.

FIG. 1 discloses aspects of an evolutionary merging model.

FIG. 2 discloses aspects of a method for populating a collection of baskets of questions, according to one embodiment.

FIG. 3 discloses aspects of a method for creation and feeding of baskets of questions (BoQ), according to one embodiment.

FIG. 4 discloses an example schematic how different domain data sources help in classifying questions and defining of a domain and reference answer for a BoQ, according to one embodiment.

FIG. 5 discloses example components for evolving more accurate and reliable metrics for a domain, according to one embodiment.

FIG. 6 discloses an example of Dw and Up distributions formed with scores computed for three different neural metrics (A, B, and C), from the best to the worst case, according to one embodiment.

FIG. 7 discloses a method for generating offspring by a strategy that combines parameter and data flow space operations, according to one embodiment.

FIG. 8 discloses a method for using refined neural metrics for a particular domain, according to one embodiment.

FIG. 9 discloses an example computing entity configured and operable to perform any of the disclosed methods, processes, and operations.

### DETAILED DESCRIPTION OF SOME EXAMPLE EMBODIMENTS

Embodiments disclosed herein generally relate to LLMs (large language models). More particularly, at least some embodiments relate to systems, hardware, software, computer-readable media, and methods, for evaluation of LLM performance.

One or more embodiments are directed to a method and/or architecture for finding, and possibly ranking, the best metrics for evaluating the performance of one or more LLMs. In one embodiment, the metrics are domain-specific, but that is not necessarily required. One example method may be implemented by a framework comprising various components.

Such a method may comprise operations including: receiving as input, by a framework, (1) one or more questions expected to be asked by a user, (2) respective answers generated by one or more LLMs for those questions, and (3) a human scoring of the LLM answers; performing an evolutionary computation approach, using the input; and, based on the evolutionary computation approach, outputting a ranking of respective metrics for each of the LLMs.

Embodiments, such as the examples disclosed herein, may be beneficial in a variety of respects. For example, and as will be apparent from the present disclosure, one or more embodiments may provide one or more advantageous and unexpected effects, in any combination, some examples of which are set forth below. It should be noted that such effects are neither intended, nor should be construed, to limit the scope of the claims in any way. It should further be noted that nothing herein should be construed as constituting an essential or indispensable element of any embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiment is that an embodiment may provide continuous monitoring of deployed LLMs/chatbots aided by reliable metrics. An embodiment may account for the fact that there is no one-size-fits-all suitable evaluation metric for LLMs. An embodiment may implement a general, intelligent framework for fine-tuning neural-based metrics. An embodiment may provide a systematic method to compare neural metrics induced by different data, hyperparameters and other settings. An embodiment may implement effective approaches for correlating neural metrics with human judgments. Various other advantages of one or more example embodiments will be apparent from this disclosure.

### A. Glossary

The following terms are used in this disclosure.

| Term | Definition |
|---|---|
| LLM | Large Language Model |
| NLP | Natural Language Processing |
| ODQA | Open-Domain Question Answering |
| MS | Metrics Scorer |
| EA | Evolutionary Algorithm |
| MO | Metrics Optimizer |
| MG | Metrics Generator |
| DP | Data Preparation |
| BoQ | Basket of Questions |
| ME | Metrics Evolution |
| DKL | Kullback-Leibler Divergence |
| JSD | Jensen-Shannon Divergence |
| RAG | Retrieval-Augmented Generation |

### B. References

Reference may be made herein to various documents. These documents are listed below and are incorporated herein in their respective entireties by this reference.
[1] Freitag, Markus, et al. “Results of WMT22 metrics shared task: Stop using BLEU-neural metrics are better and more robust.” Proceedings of the Seventh Conference on Machine Translation (WMT). 2022. https://aclanthology.org/2022.wmt-1.2/
[2] Akiba, Takuya, et al. “Evolutionary Optimization of Model Merging Recipes.” arXiv preprint arXiv:2403.13187 (2024). https://arxiv.org/abs/2403.13187
[3] Zhang, Tianyi, et al. “BERTScore: Evaluating text generation with Bert.” arXiv preprint arXiv:1904.09675 (2019). https://arxiv.org/abs/1904.09675
[4] Sellam, Thibault, Dipanjan Das, and Ankur P. Parikh. “BLEURT: Learning robust metrics for text generation.” arXiv preprint arXiv:2004.04696 (2020). https://arxiv.org/abs/2004.04696
[5] Rei, Ricardo, et al. “COMET: A neural framework for MT evaluation.” arXiv preprint arXiv:2009.09025 (2020). https://arxiv.org/abs/2009.09025
[6] Bartz-Beielstein, Thomas, et al. “Evolutionary algorithms.” Wiley Interdisciplinary Reviews: Data Mining and Knowledge Discovery 4.3 (2014): 178-195.
[7] Young, Steven R., et al. “Optimizing deep learning hyper-parameters through an evolutionary algorithm.” Proceedings of the workshop on machine learning in high-performance computing environments. 2015.
[8] Tani, Laurits, et al. “Evolutionary algorithms for hyperparameter optimization in machine learning for application in high energy physics.” The European Physical Journal C 81 (2021): 1-9.
[9] Yadav, Prateek, et al. “Ties-merging: Resolving interference when merging models.” Advances in Neural Information Processing Systems 36 (2024).
[10] Deb, Kalyanmoy, et al. “A fast and elitist multiobjective genetic algorithm: NSGA-II.” IEEE transactions on evolutionary computation 6.2 (2002): 182-197.
[11] Yu, Le, et al. “Language models are super mario: Absorbing abilities from homologous models as a free lunch.” Forty-first International Conference on Machine Learning. 2024.
[12] Chan, Kit Yan, et al. “A roulette wheel-based pruning method to simplify cumbersome deep neural networks.” Neural Computing and Applications (2024): 1-19.

### C. Aspects of an Example Context for One Embodiment

The following is a discussion of aspects of an example context for various embodiments. This discussion is not intended to limit the scope of the claims or this disclosure, or the applicability of the embodiments, in any way.

### C.1 Automatic Evaluation of Large Language Models (LLM)

Measuring the quality and effectiveness of LLM-based applications is a critical step in the path from development to production. Because of this, the industry and academia are putting huge efforts in developing evaluation methods to proper assess the performance of these models. The major challenge lies in the fact that, although the standard evaluation of traditional Machine Learning models is straightforward, given human labeling, for LLMs the ground truth is sparse and often very hard to determine entirely. For example, numerous responses for the same question can be considered correct even they are syntactically different. To deal with this, automatic metrics capable of capture the semantic of the LLMs answers have been more and more adopted. See, for example, BERTScore [3], BLEURT [4], COMET [5], which basically encode contextual embeddings from a LLM answer and an expected answer to obtain a score based on similarities between them which, conveniently, does not rely on exact matches.

For all intents and purposes, however, as automatic metrics are trained deep neural architectures, they suffer from the same problems found in non-deterministic data-driven models. In other words, these neural metrics rely on the quality of the training data, and present difficulties in find the best hyperparameters to use, such as for a particular problem, for example. This can lead them to ineffective training, provoking under/overfitting, biases, and low capacity of generalization, for example. As a result, these metrics can unintentionally distort the calculated scores tricking the evaluation process of LLMs.

### C.2 Evolutionary Algorithms

Evolutionary Algorithm (EA) is an umbrella term used to describe population based stochastic direct search algorithms that in some sense mimic the Darwinian theory of evolution [6]. In this manner, EA establishes a generic recipe for probabilistically exploring the search space to find the best solution for a problem at hand. In more detail, a population consists of points in the search space, named as individuals, or solution candidates, which are attached a fitness value. The value of fitness is a number that quantifies how good an individual is at solving a target problem. Through a continuous procedure of variation and selection of individuals, successive improvements of the solutions, by way of parents generating offspring, take place in order to find the best answer to a problem.

Variation operators produce genetic diversity that is typically achieved by recombination (crossover) and mutation. In the crossover operation, the parent genetic material is exchanged to form new individuals. Mutation, on the other hand, aims to insert random changes into the offspring to try to avoid local minima solutions.

After crossover and mutation operators have been applied, the EA imposed control flow considers a competition for survival in which replacement strategies are applied, for example generational replacement or elitism, to determine which individuals, from the current population and their generated offspring, will be in the next generation, this is the so-called environmental selection or survival selection. Such a selection intentionally introduces a bias towards better fitness values, so that individuals better adapted to the environment are preferred to be selected. It is noted that this selection operator is also used when parents need to be selected to generate offspring. After this mating selection, the chosen parents perform crossover/mutation, as described above.

Selection, crossover, mutation, and replacement strategies are applied from generation to generation until a termination criterion is reached, for example a threshold of population average fitness is achieved. Finally, it is noted that EAs have been successfully applied to optimize the hyperparameters of Machine Learning methods/algorithms. See [7] and [8]. Recently, new approaches employing EAs in optimizing parameters, layers and weights, of deep neural networks are also being proposed [2].

### C.3 Model Merging

Model merging is a recent development in the LLM community, whose strategy is based on combining multiple LLMs into a single architecture. This idea has attracted attention because it avoids additional training for the generation of new, specific, models. However, model merging depends to a significant extent on the experience of the “model maker,” which may be a human, who must have the intuition and domain knowledge to know what to select, how to combine in order to finally generate new better models, for example, for a particular domain.

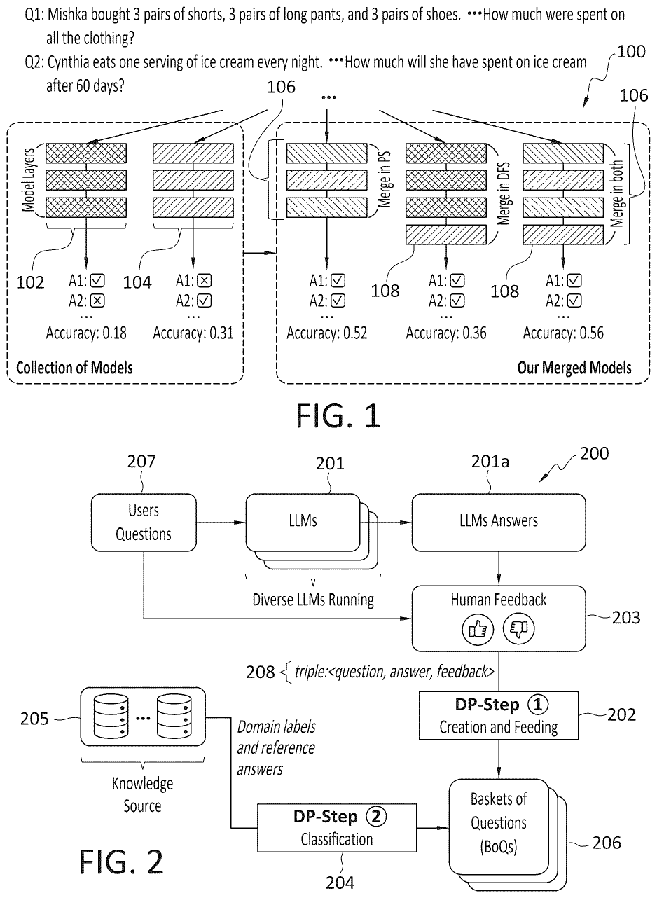

FIG. 1 depicts a schematic representation of an evolutionary approach involving model merging that guides merged models according to a fitness function based on accuracy and ROUGE measurements. More particularly, FIG. 1 discloses an evolutionary model merging 100 (See [2]). In FIG. 1, models 102 and 104 have three layers with weights mixed to form three new layers (PS) 106, while a fourth layer 108 is added (DFS) to complete the final merged model.

### D. Overview of Aspects of One Embodiment

One or more embodiments comprise a framework to smartly find the best neural-based metrics for different contexts/domains of questions answered by LLM-based systems/chatbots. This framework receives questions, their corresponding LLMs answers and a simple human score as a judgment of them. After an evolutionary computation approach, its output is a ranking of accurate metrics for model evaluation in the captured context/domain.

One example embodiment of a framework comprises three components, namely: Metrics Scorer, Metrics Optimizer, and Metrics Generator. These are each briefly described below:
Metrics Scorer (MS)—measures the fitness of trained neural metrics. A goal of an Evolutionary Algorithm (EA) is to evolve a population of candidate solutions over successive generations, aiming at improving their performance on a given problem. The fitness function assigns a numerical value to every individual in the population based on how well it solves the problem at hand. The algorithm uses the calculated fitness to guide the search for the best solutions. For our problem, given a set or population of trained neural metrics, the MS component aims at obtaining the fitness value for each one. To do this, one embodiment comprises a fitness function that measures the adherence of the scores computed by a neural metric to human judgments on a set of questions and LLM answers. This adherence can be calculated as a divergence between two distributions drawn by neural metric scores: one distribution covering LLM answers voted as “thumbs down” by humans, and the other distribution comprising “thumbs up” answers. Since a reference answer is required to calculate the neural metric scores, an embodiment may obtain it by matching identical/similar questions to questions from a labeled benchmark dataset. If this benchmark dataset refers to a specific task/domain, the evolutionary algorithm will then be guided in its search for metrics suitable for its context.
Metrics Optimizer (MO)—optimizes neural metrics for a specific task/domain. By using the fitness function, the quality of individuals (neural metrics) of a particular generation is measured. This quality reflects how accurate and reliable a metric is for the domain/context handled. Inspired by the process of natural selection and genetics, these neural metrics are then chosen, with a probability proportional to their fitness, to reproduce offspring and carry the present generation ahead. By applying specialized operators to the selected individuals, new individuals, that is, new versions of the parent neural metrics, are created. In more detail, and as typically carried out in Evolutionary Computation, operators for recombination, or crossover, to exchange genetic material such as hyperparameters for example, between individuals, and mutation, to insert random changes in the offspring, can be applied. Finally, the MO component uses replacement strategies, such as generational replacement or elitism for example, to determine which individuals, from the current population and generated offspring, will be in the next generation. This process can be repeated until a certain number of generations or until a termination criterion is met, for example, a threshold of average fitness of the generation can be defined.
Metrics Generator (MG)—creates new neural metrics versions from others. This component is responsible to generate individuals for a next generation of the process carried out by MO component. These generated individuals are modified neural metrics resulting by the application of operators, such as crossover operators, and mutation operators, on neural metrics selected in a certain generation. In more detail, the operators can change hyperparameters that are used only during model's prediction, so retraining won't be necessary. However, other hyperparameter changes may involve retraining of the neural metric; for example, when modifying the learning rate. Operators can also be specialized in mixing the weights of two models and/or combining their layers to form offspring, as in [2]. Hence, the MG component must deal with these particularities and apply the necessary changes in order to generate new individuals from parents and make them available to the MO component, which will continue with the optimization process.

As exemplified by the foregoing, and the rest of this disclosure, one or more embodiments may comprise various useful features and advantages, although no embodiment is required to possess any of such features or advantages. The examples discussed below are illustrative, but not exhaustive.

Currently, there is no one-fits-all evaluation metric for LLMs. Conventional approaches generally choose one or more metrics that are assumed to be acceptable, which can result in inaccurate results; and/or employs a fully manual evaluation approach, which can be extremely costly. In this context, the following are some example features and aspects that may be included in one or more embodiments:
Support to continuous monitoring of deployed LLMs/chatbots providing accurate and reliable metrics as the domain/context change.
Optimization of any trainable metric in background/parallel with multiple LLMs/chatbots already in use.
The use of (small) benchmarks to specialize metrics for a certain domain/context for which they can evolve over time so that the best metrics are selected to be used when necessary.
Reliability/accuracy of the metrics as they are aligned with human preferences by taking into account a simpler and faster thumbs up/down vote, instead of complex manual methods based on scoring the answers or choosing the best answer between two or more.

### E. Detailed Discussion

### E.1 Introduction

At present, there is no known existing framework able to systematically adapt neural metrics to a domain taking human judgements into account. Given that manual evaluation is extremely expensive, subjective, and the least scalable method, some efforts are trying to replace the human-in-the-loop with stronger LLMs as a judge, such as GPT-4. In this method, LLM agents act like humans voting for the best answers generated by the LLM under evaluation. However, such an automatic evaluation assumes that there is an accurate LLM capable of making judgments, which can be hard to ensure and costly to maintain, since the best models are not open source, for example.

One embodiment submits smaller LLMs as metrics, capable of scoring the responses generated, to an evolutionary procedure that improves them to make them more accurate. This process is guided by low-cost human judgments, so it can be understood as a mixture of manual evaluation and an automated evaluator, which is optimized for certain domains/contexts. Therefore, a framework according to one embodiment is a more reliable alternative for the evaluation of LLM-based systems/chatbots.

That is, to overcome some known shortcomings, an embodiment comprises a framework for the evolution of metrics towards their best settings when evaluating LLMs/chatbots according to a context/domain of questions. One embodiment uses stochastic search guided by human judgments to find the best metrics and their best configurations for LLMs/chatbots evaluation according to their domain/context.

### E.2 Discussion

As noted herein, one embodiment comprises a framework for optimizing neural metrics for questions that LLMs/chatbots are answering in order to increase the reliability of the automatic evaluation of these models. In an embodiment, such a framework is divided into two parts. The first of these two parts is related to the data preparation, which will be used to evolve neural metrics afterwards. In an embodiment, this Data Preparation (DP) part comprises two elements:
1. To create the so-called Baskets of Questions (BoQs), which will hold triples with a question, the corresponding LLM response, and a human vote as being “thumbs up” (LLM answer is OK) or “thumbs down” (LLM answer is not OK). Identical (and/or very similar) questions asked to LLMs will be grouped together in the same BoQ.
2. To assign a domain label to each question in each BoQ using an external knowledge base containing different data sources, each one from a specific context/domain—where some example domains include, but are not limited to, science, agriculture, and healthcare. A unique reference response will be also attached to each BoQ according to its questions. In an embodiment, the reference responses will come from the data sources as they also need to contain ground-truth answers for their questions.

The second part of a framework according to one embodiment is dedicated to the Metrics Evolution (ME) part, which is where a set of pre-trained, standard neural metrics are optimized through an evolutionary approach. This is guided by the annotated human feedback, that is, the “thumbs up” and “thumbs down” process, and a particular context/domain as determined by the BoQs. As a result, a ranking of the best-fit metrics for a given context/domain will be made available. In the following sections, example embodiments of the DP and ME parts of a framework are described in more details.

### E.2.1 Data Preparation (DP) Part

This section clarifies how data is prepared and organized to be properly used in the Metrics Evolution (ME) component ahead. With reference now to FIG. 2, there is disclosed a schematic 200 of the two steps for populating a collection of Baskets of Questions (BoQs) through deployed LLMs 201, low-cost human feedback 203, and a knowledge base 205 with data from different (target) domains. Specifically, a Data Preparation (DP) component couples to an operating LLM/chatbot pipeline to execute two steps 202 and 204 (DP-Step 1 and DP-Step 2), as shown in FIG. 2. While DP-Step 1 is responsible to create and feed Baskets of Questions (BoQs) 206, DP-Step 2, in its turn, classifies BoQs as belonged to a specific domain and assign to every BoQ a reference answer related to the questions it gathers. Each of these DP steps 202 and 204 is discussed in more detail below.

### E.2.1.1 DP-Step 1—Creation and Feeding of Baskets of Questions (BoQs)

In this step, indicated at 202 in the example of FIG. 2, the objective is to create Baskets of Questions (BoQs) or to feed an existing BoQ with a new triple. A triple 208 comprises (1) a question 207, (2) an LLM answer 201a, and (3) the human feedback (thumbs up/down) 203, as shown in FIG. 2.

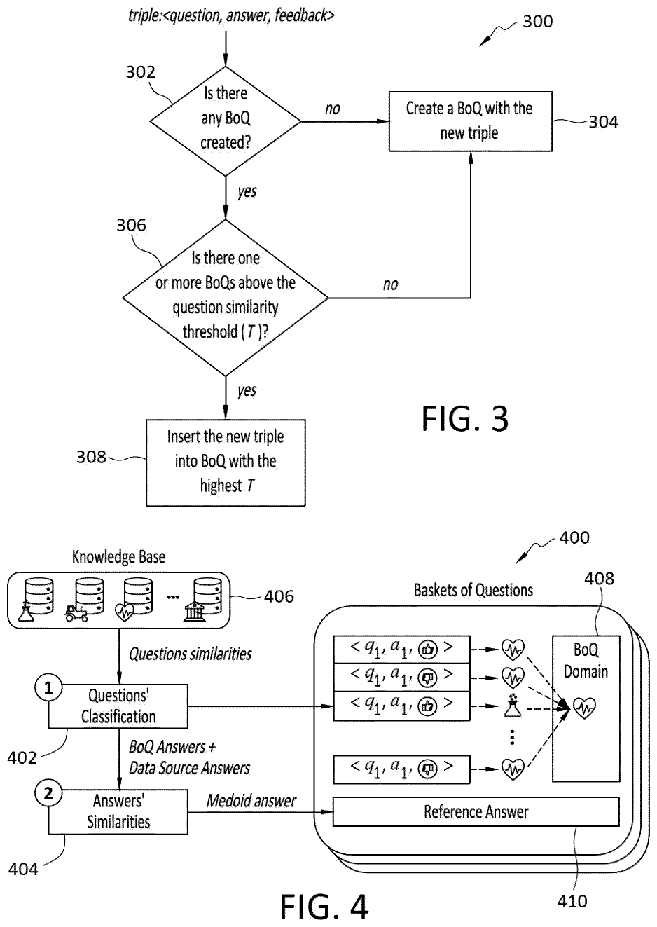

In an embodiment, and with reference now to the example method 300 disclosed in FIG. 3, to create the first BoQ, a check 302 may be performed and when the collection of BoQs is empty, a BoQ created 304 with and the triple is stored in it. From this, with the collection containing one or more BoQs, there will be two options: either a new triple will be inserted into an existing BoQ or it will form another BoQ. The flowchart in FIG. 3 illustrates this process, indicating an example of the DP-Step 1 to create and feed BoQs.

To decide the destination of the triple, an embodiment may employ a threshold of text similarity, for example, T=0.8, from a restrictive similarity measure based on n-gram overlap, such as a Bleu score for example, which is highly lexical oriented, that is, it observes only identical sequences of words without considering semantic. Then, a new triple that has its question compared to all questions of a BoQ providing an average similarity equal to or higher than T, should join this BoQ. In the case it is determined 306 that there are more BoQs with average score above T, the triple must be inserted 308 into the BoQ that yielded the highest T. If the new triple question does not reach this threshold for any of existing BoQs, it will form a new BoQ, as indicated at 304.

### E.2.1.2 DP-Step 2—Baskets of Questions (BoQ) Classification

This step operates to assign a reference answer to each BoQ, taking into account the classification of its questions. This process will help to define the context/domain that the BoQ represents. For reasons of relevance to a Metrics Evolution process, discussed below, only BoQs above a number Num, of questions, and a proportion of answers annotated as “thumbs up” and “thumbs down” above Prop will be processed in DP-Step 2.

FIG. 4 depicts the two main procedures performed in this step. That is, FIG. 4 discloses a schematic 400 of how different domains data sources help in classifying questions and defining of a domain and reference answer for a BoQ.

Specifically, all questions from BoQs are classified 402 and a reference answer is attached to each BoQ according to similarities 404 to data sources that form a given knowledge base 406. In an embodiment, these data sources are basically domain-specific datasets that could be sampled from known datasets relating to downstream tasks and/or manually crafted from business data. In the example of FIG. 4, the data sources of the knowledge base 406 contain specific subjects, such as science, agriculture, healthcare, and others.

To classify 402 questions from a BoQ, a similarity is gauged with regard to the set of data sources. In more depth, a pre-trained BERT-based model capable of capturing the semantic similarity between two sentences may be employed to measure how close a BoQ question is to all the existing questions in the knowledge base. The BoQ question is then classified, or labeled, as being from the same domain as the data source that offers the highest average similarity regarding its questions. FIG. 4 emphasizes that after performing this classification procedure, each question (qᵢ) will allow its corresponding triple to be assigned to a context/domain from those existing in the knowledge base 406. A single context/domain for the BoQ is then defined by majority vote of triples classification, such as the healthcare domain 408 for the BoQ exemplified in FIG. 4.

Finally, an embodiment may find the most representative BoQ reference answer 410. This is done by gathering all the BoQ answers associated with “thumbs up” and whose domain is the same as the BoQ domain, determined in the previous step: ‘healthcare,’ as exemplified in FIG. 4. This set of answers is then expanded by the increment of answers from the data source from the same domain as the BoQ. This is done by bringing the data source answers that are most similar to each of the answers already in the set, here, semantic measures may be used. Therefore, this operation will double the number of answers in the set, because each BoQ answer in the set will be responsible for picking up an answer from the data source, even if it is repeated. As these answers are assumed to be correct, since the data sources handled are considered supervised data with ground truth, and these answers may in fact be the ground truth, from them an embodiment may obtain reliable responses for the BoQ. Once the set of answers is complete, the reference answer 410 of the BoQ is identified as the one that offers the lowest average similarity to all the other answers in the set. This medoid answer is then attached to the BoQ, as shown in FIG. 4.

### E.2.2 Metrics Evolution (ME)

In an embodiment, the Metrics Evolution (ME) process serves to build a ranking of best metrics for each domain annotated. These domains are those from data sources in the knowledge base, as discussed above in connection with FIG. 4. Since Baskets of Questions (BoQs) were classified according to the domain they belong, the first step here is to group these BoQs by domains. BoQs from a specific domain will then provide data to an Evolutionary Algorithm (EA) aiming to improve neural metrics, for example, BERTScore, BleuRT, and COMET, for such a domain. In this way, a ranking of the best evolved metrics for this domain will be made available.

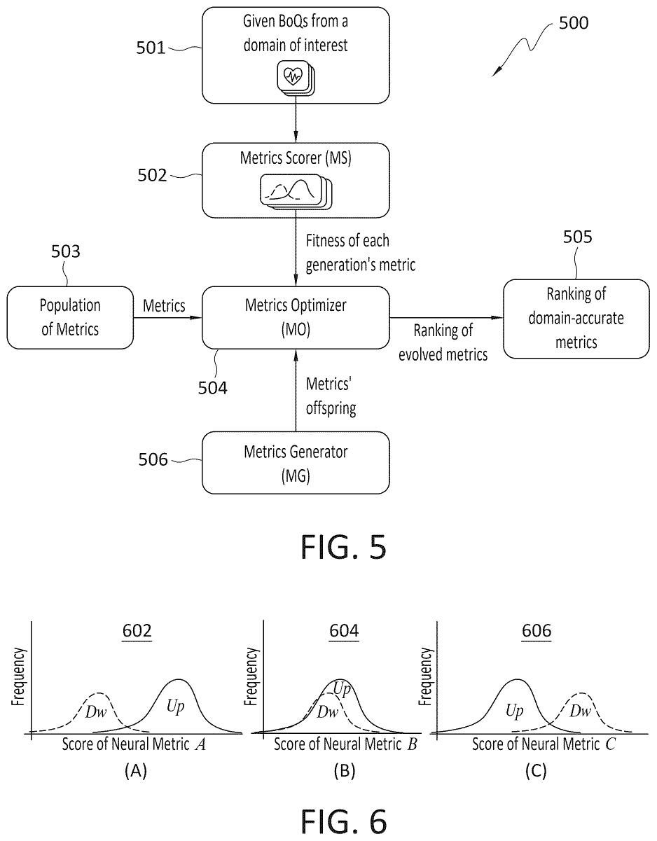

FIG. 5 discloses an example schema 500 for evolving more accurate and reliable metrics for a domain. In an embodiment, a metrics evolution process may be implemented by various components, namely: Metrics Scorer (MS) 502, Metrics Optimizer (MO) 504, and Metrics Generator (MG) 506. FIG. 5 discloses the relationships between/among these components. As shown, the MS 502 receives domain BoQs information 501 to measure the fitness of candidate neural metrics 503, while the MO 504 encompasses the EA itself that uses calculated fitness to guide the neural metrics for better versions. For this, new controlled neural metrics versions may be created, and this is the task of the MG 506 component. After a certain number of iterations/generations, MO 504 will output the ranking 505 of evolved neural metrics for the domain under consideration. Each of these components is discussed in more detail below.

### E.2.2.1 Metrics Scorer (MS)

In an embodiment, the MS component (see FIG. 5) operates to calculate the fitness of each neural metric, or candidate solution, present in a population of metrics. Considering the example problem scenario, the fitness function measures the adherence of neural metrics to human judgments within a specific domain, through the corresponding BoQs. In this way, an adherence score is obtained as a weighted divergence between two distributions, both drawn by calculated scores of a neural metric, Mᵢ∈P={M₁, M₂, . . . , M_{N}}. Specifically, after computing Mᵢ scores on LLMs answers with respect to reference answer, both contained in a given Bag of Questions, BoQⱼ, j={1, . . . , K}, related to a domain, Dₗ, l={1, . . . , R}, a distribution named Dw and another named Up are defined. Distribution Dw contains only scores produced with LLM answers assigned as “thumbs down”—observing the annotation in BoQⱼ—while the distribution Up only holds scores from generated answers that received “thumbs up.”

To better understand how the fitness works, consider the examples depicted in FIG. 6, which discloses Dw and Up distributions formed with scores computed for three different neural metrics 602, 604, and 606 (A, B, and C), from the best case to the worst case. It may be expected for distributions Dw and Up to have as little overlap as possible, with Up containing scores as high as possible as compared with those from Dw, as illustrated in 602. In contrast, a significant overlap of Up with Dw, as exemplified in 604, must demote the fitness of a metric by the same amount. This penalty can be expected to occur more harshly in the worst case, shown in 606, when distribution Up has a majority of scores below those scores found in Dw. This worst case means that the metric is giving lower scores to answers judged as good (thumbs up), while the highest scores are for those judged as bad (thumbs down). This behavior is the opposite of the adherence to human judgments that is being sought. Note that here it is assumed that metric scores vary between 0 and 1, where the higher the score, the better the answer.

The rationale above is captured by the fitness function (1) described below:

$${Fitness}_{{M}_{i} , {BoQ}_{j}} = ( Median ( {Up}_{{M}_{i} , {BoQ}_{j}} ) - Median ( {Dw}_{{M}_{i} , {BoQ}_{j}} ) ) * JSD ( {Dw}_{{M}_{i} , Bo {Q}_{j}} , {Up}_{{M}_{i} . {BoQ}_{j}} )$$

Here, the fitness function equation (1) computes the fitness for a neural metric Mᵢ on the j-th BoQ, which is given by the Jensen-Shannon Divergence (JSD) between the distributions Dw and Up weighted by the difference between median of Up and median of Dw. The Jensen-Shannon Divergence is a symmetric metric that measures the relative entropy in information between two distributions, similar to Kullback-Leibler Divergence (DKL). Basically, JSD quantifies how different the two distributions are from each other.

Given the fitness for each BoQⱼ belonged to a domain Di, the complete fitness for Mᵢ can be calculated as the average of them. The next ME component may require the average fitness of all the metrics considered in a generation.

### E.2.2.2 Metrics Optimizer (MO)

In an embodiment, the MO component uses Evolutionary Algorithms (EAs) to evolve neural metrics for a specific task/domain, Dₗ, l={1, . . . , R}, taking into account its K related BoQs. The MO component may offer general guidelines to stochastically find the best solutions for a given problem that comprises performing four steps that may be performed iteratively, namely: Selection, Crossover, Mutation, and Replacement Strategies.

In the Selection step, the fittest individuals are privileged. For instance, a simple approach to be adopted in this case is the Roulette Wheel strategy (see [12]), which mimics the idea of a casino roulette, in which each slot represents an individual, such as a particular neural metric. However, an embodiment may assume that the size of the slots are proportional to the fitness of the individual. In this sense, neural metrics exhibiting higher fitness, according to Equation (1), have more chances to be selected than those scoring low after spinning the roulette wheel. An embodiment may use this strategy to select parents, who will then generate offspring through Crossover/Mutation. Other selection methods may be alternatively adopted, such as those based on tournament, ranking, stochastic universal sampling.

The next step, Crossover, occurs after Selection. It is based on the reproduction of biological organisms, whose objective is to create offspring by mixing genetic information from parents. For one case, this recombination process can take place in four different spaces:

### Hyperparameter Space:

Typically, neural metrics depend on hyperparameters to be set in order to output their scores. For example, BERTScore requires the information of layer of representation to use, which can variate from 1 to 12, 16, or 24, according to the total number of layers of the model, which can also vary. In this case, alternatives for recombination can simply consider exchanging the hyperparameter value between the two selected parents or calculating the average of them and defining this new value in the offspring genotypes.

### Model Space:

Neural metrics use a pre-trained model to perform their evaluation, so that a wide range of models, according to the metric, can be set. This situation is similar to the hyperparameter space, above, that is, it leads to the problem of manually selecting the best configuration, or model, in this case, for an application, but this may be automated with AEs.
In more detail, most of neural metrics' models are based on Bidirectional Encoder Representations from Transformers (BERT) architecture. For example, BLEURT has more than ten official checkpoint models that can be used, including for example, BLEURT-20-D3, BLEURT-20-D6, BLEURT-20-D12, and BLEURT-20 (see [4]). BERTScore, in turn, must use one of the twelve existing official pre-trained models, for example, bert-base-uncased, bert-large-uncased, roberta-base, roberta-large, and xlnet-base-cased (see [3]), while COMET has seven models to be chosen, including wmt22-comet-da, wmt20-comet-qe-da, wmt21-comet-mqm, and wmt21-cometinho-da (see [5]).
A simple way of optimizing the model is to assume an indexed list of models for each metric, ordered by model complexity for example. Individuals could carry a gene that is the index of the used model. This gene could then be exchanged between parents, or an average of them could be calculated to be in the chromosomes of the offspring—it is noted that in this space, crossover can only occur if parents are the same neural metric.

### Parameters Space:

In this space, the objective is to recombine the weights of parent models. For example, this can be implemented employing the approach in [2], which is based on an approach that uses TIES-Merging (see [9]) with DARE (see [11]) for layer-wise merging. In this space, the recombination process may take into consideration a percentage, such as up to 20% for example, of equivalent layers of the same size to have their weights merged, thus forming new individuals with these merged weights' layers.

### Data Flow Space

This space is related to the optimization of the inference path that tokens follow as they traverse through the neural network. For example, after the i-th layer in model Mₐ, a token may be directed to the j-th layer in model M_{b}. Joining all layers from two parent models, we can access all possible distinct paths, from which a path could be picked, for example, by randomly choosing a certain number of these layers. By setting this path in the offspring, it could then carry layers from both parents. In more detail, this recombination could take in consideration a percentage, such as up to 20% for example, of layers from Mₐ to be replaced by others with the same size from M_{b}. This will provide a smaller search space as a more efficient way of optimizing the data flow space.

Evolving spaces, as discussed above, is cheaper than the computational effort required to fine-tune the models (see [2]). In addition, optimizing one or more of these spaces unleashes a collective intelligence that takes advantage of the best “part” of each neural metric to generate more advanced metrics that might never be discovered through fine-tuning.

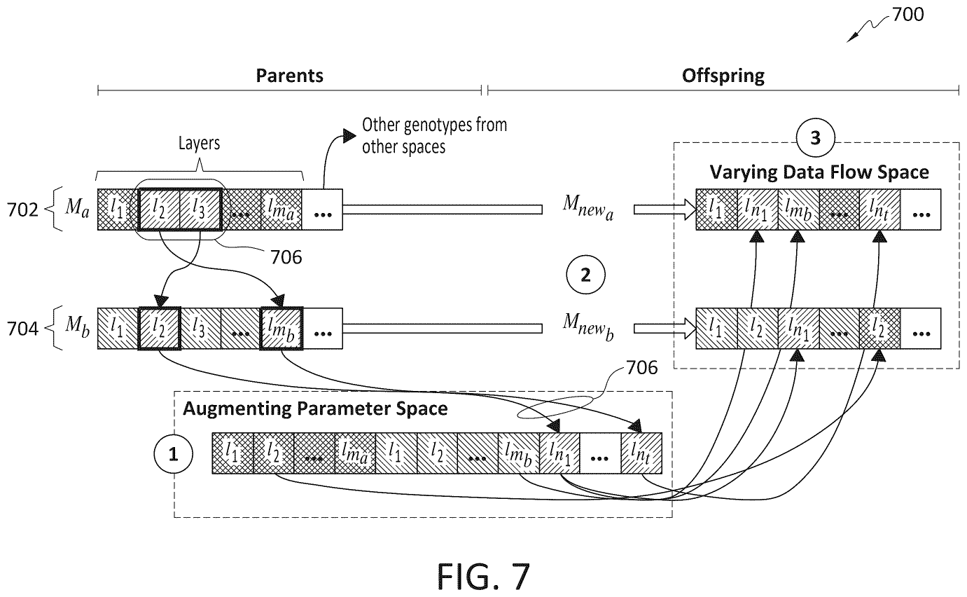

FIG. 7 illustrates a three-step crossover that gently combine parameters and data flow space optimization. That is, FIG. 7 discloses a schema 700 for generating offspring by a strategy that combines parameter and data flow space operations. First, given two parent models Mₐ 702 and M_{b} 704, expressed by a set of genes, some pairs such as 706 are chosen for parameter merging operation, which may be the same method for parameter space recombination discussed earlier herein. This will result in a set of new layers with merged weights.

To conclude Step 1 (Augmenting Parameter Space), these new layers are then inserted in a list of layers that also contain all the original parents' layers from Mₐ and M_{b}. Step 2, in turn, replicates the original Mₐ and M_{b} genes forming two new individuals. Finally, in Step 3 (Varying Data Flow Space), some layer genes of these new individuals are replaced by randomly selected genes from the list built in Step 1, that is equivalent to recombine the data flow space. To illustrate, M_{new}_{ₐ} had three genes replaced with merged ones and a gene from M_{b}, while M_{new}_{_{b}} had two replacements, one refers to a merged gene and another is a gene from Mₐ. After Step 3, the resulting M_{new}_{ₐ} and M_{new}_{_{b}} are the new individuals that may be promoted to a next generation of the evolutionary process.

After Crossover, a Mutation operator can be alternatively applied, and one embodiment assumes that this Mutation operator is optional. In any case, mutation is responsible for inserting random changes in one or more genes in the offspring. This perturbation helps explore new regions of the search space and prevents premature convergence to suboptimal solutions. As an example, the representation layer of a BERTScore individual could be randomly altered, such as within an admissible range of values, the same for the weights from a particular offspring layer.

In an embodiment, the last step of an EA approach uses a Replacement Strategy to determine which individuals, from the current population, that is, parents, and those generated offspring), will be in the next generation. A simple strategy here is to generate offspring up to the total number |P| of individuals of the population, keep them for the next generation, and extinguish their parents. Another way is to run the Selection step again and keep only the |P| fittest individuals among parents and offspring.

Thus, in an embodiment, Selection, Crossover, Mutation, and Replacement are repeated iteratively until a certain number of generations, or a termination criterion is met. For example, this iterative process may continue until a minimum difference between the average fitness of two consecutive generations is obtained.

### E.2.2.3 Metrics Generator (MG)

In an embodiment, the MG operates to create new neural metrics, that is, individuals/offspring, and return them to the MO component, in its last step of Replacement. As such, an embodiment of the MG encapsulates the process of reproduction, receiving two parents and a set of instructions to produce new individuals. For example, MO defines which selected parents, such as a percentage of parents, will undergo a process such as the example disclosed in FIG. 7, and MG executes that process, Steps 1 through 3 in FIG. 7, to obtain new genotypes. MG also communicates with the genotypes to provide their respective neural metrics, or phenotype, ready to be executed and/or stored, if necessary. They are then made available to the MO component.

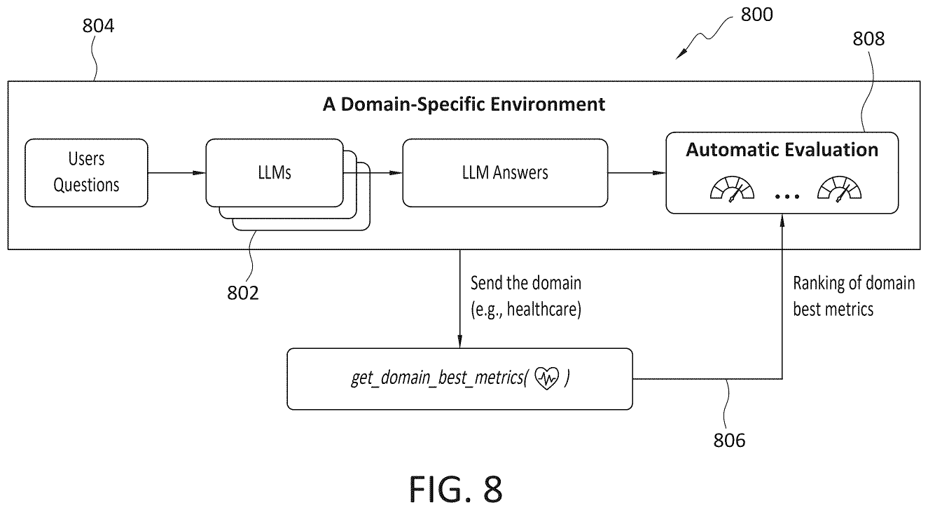

As the MG may store evolved neural metrics, those metrics exhibiting the best performance, according to a given domain, are then ranked to be used in a phase of automatic evaluation. The schema 800 disclosed in FIG. 8 exemplifies this phase, when deployed LLMs 802 are performing within a known domain-specific environment 804. From this, the next process is concerned with receiving the LLM domain 804, healthcare in the illustrative example of FIG. 8, and then returning a ranking 806 of the best, or refined, neural metrics found for that particular domain.

The selected metrics for a particular domain can be used for a more reliable and accurate evaluation 808 of LLMs and/or RAG (Retrieval-Augmented Generation) systems operating, for example, on business/specific data. Alternatively, the knowledge base may contain only data from this particular domain, that is, the knowledge database may comprise the RAG database itself. Thus, a framework according to one embodiment enables greater flexibility by being able to store various neural metrics adapted to different domains, with the specialization of each one occurring from questions, answers, and feedbacks, coming from real interactions between users and LLMs, and biased by a given knowledge base intentionally chosen to evolve metrics for a target segment. Also, it is possible, in an embodiment, to select the best neural metric from all the domains to evaluate the systems as a whole.

### E.3 Further Discussion

As disclosed herein, evaluating the performance of LLMs is challenging and there is no ‘silver bullet’ approach for dealing with this challenge. A conventional approach is to select one or more metrics that are assumed to be acceptable, which can result in inaccurate results, and/or employ a fully manual evaluation approach, which can be extremely costly in terms of time and/or computing resource and communication resource consumption. By way of contrast, one embodiment submits smaller LLMs, as metrics that are capable of scoring the responses generated, to an evolutionary procedure that improves them to make them more accurate and reliable. Such a process may be guided by low-cost human judgments, such that it may comprise a mix of manual evaluation and an automated evaluator that can be optimized for certain domains/contexts.

As disclosed herein, one or more embodiments, such as a framework, may, but are not required to, possess various useful features and functionalities. Such features and functionalities may include, for example: (i) a framework may support continuous monitoring of deployed LLMs/chatbots, providing accurate and reliable metrics as the domain/context changes; (ii) a framework may optimize any trainable metric in background/parallel with various LLMs/chatbots already in use; (iii) a framework may specialize metrics for a given domain/context for which they may evolve over time, so that the best metrics are selected to be used when needed; and (iv) a framework may provide a more reliable alternative for evaluating LLMs/RAG-based systems, aligning evaluation metrics with human preferences rather than complex manual methods based on scoring responses or choosing the best answer from two or more.

### F. Example Methods

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

### G. Further Example Embodiments

Following are some further example embodiments. These are presented only by way of example and are not intended to limit the scope of this disclosure or the claims in any way.
Embodiment 1. A method for selecting a metric to evaluate LLM (large language model) performance, comprising: receiving, as input, a BoQ (basket of questions) from a domain of interest, LLM-generated answers to each of the questions, and a respective human-generated score for each of the LLM-generated answers; obtaining respective fitness measurements, based on the input, for each neural metric in a population of neural metrics usable to evaluate a performance of the LLM when responding to a user inquiry; using, by an EA (evolutionary algorithm), the fitness measurements to generate evolved neural metrics based on the neural metrics for the domain of interest, and generating the evolved neural metrics comprises generating a respective new version for one or more of the neural metrics for the domain of interest; and outputting a ranking of the evolved neural metrics according to a respective quality of each of the evolved neural metrics, and the quality of one of the evolved neural metrics indicates an accuracy and reliability of that evolved neural metric in indicating a performance of the LLM with respect to questions from the domain of interest.
Embodiment 2. The method as recited in claim 1, wherein the LLM comprises a virtual assistant.
Embodiment 3. The method as recited in claim 1, wherein the fitness measurements are obtained using a fitness function that measures an adherence of a respective score computed by each of the neural metrics to a corresponding one of the human-generated scores.
Embodiment 4. The method as recited in claim 1, wherein the EA employs an iterative process to generate the evolved neural metrics.
Embodiment 5. The method as recited in claim 4, wherein the iterative process comprises operations performed with respect to the neural metrics and/or the new versions of the neural metrics, and the operations include selection, crossover, mutation, and replacement.
Embodiment 6. The method as recited in claim 1, wherein the new versions of the neural metrics are generated by applying one or more operators to the neural metrics.
Embodiment 7. The method as recited in claim 6, wherein the one or more operators comprise a crossover operator, and a mutation operator.
Embodiment 8. The method as recited in claim 1, wherein performance of the LLM is monitored continuously and one or more of the evolved neural metrics is updated when a change to the domain is detected.
Embodiment 9. The method as recited in claim 1, wherein each of the human-generated scores comprises either a ‘thumbs up’ vote or a ‘thumbs down’ vote.
Embodiment 10. The method as recited in claim 1, wherein one of the evolved neural metrics is an offspring of another evolved neural metric and/or of one of the neural metrics in the population of neural metrics.
Embodiment 11. A system, comprising hardware and/or software, operable to perform any of the operations, methods, or processes, or any portion of any of these, disclosed herein.
Embodiment 12. A non-transitory storage medium having stored therein instructions that are executable by one or more hardware processors to perform operations comprising the operations of any one or more of embodiments 1-10.

### H. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

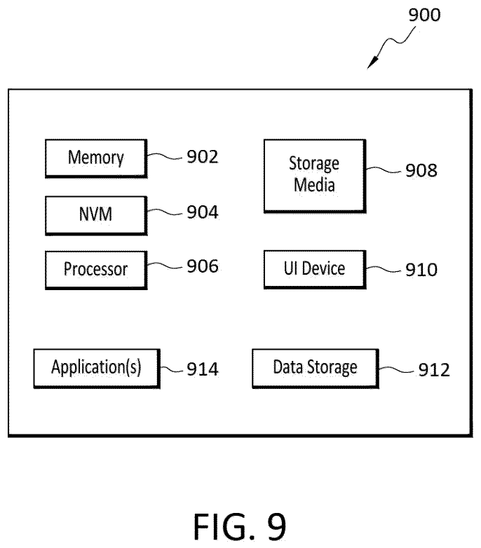

With reference briefly now to FIG. 9, any one or more of the entities disclosed, or implied, by FIGS. 1-8, and/or elsewhere herein, may take the form of, or include, or be implemented on, or hosted by, a physical computing device, one example of which is denoted at 900. As well, where any of the aforementioned elements comprise or consist of a virtual machine (VM), that VM may constitute a virtualization of any combination of the physical components disclosed in FIG. 9.

In the example of FIG. 9, the physical computing device 900 includes a memory 902 which may include one, some, or all, of random access memory (RAM), non-volatile memory (NVM) 904 such as NVRAM for example, read-only memory (ROM), and persistent memory, one or more hardware processors 906, non-transitory storage media 908, UI device 910, and data storage 912. One or more of the memory components 902 of the physical computing device 900 may take the form of solid state device (SSD) storage. As well, one or more applications 914 may be provided that comprise instructions executable by one or more hardware processors 906 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The described embodiments are to be considered in all respects only as illustrative and not restrictive. All changes which come within the meaning and range of equivalency of the claims are to be embraced within their scope.

What is claimed is:

1. A method for selecting a metric to evaluate LLM (large language model) performance, comprising:
receiving, as input, a BoQ (basket of questions) from a domain of interest, LLM-generated answers to each of the questions, and a respective human-generated score for each of the LLM-generated answers;
obtaining respective fitness measurements, based on the input, for each neural metric in a population of neural metrics usable to evaluate a performance of the LLM when responding to a user inquiry;
using, by an EA (evolutionary algorithm), the fitness measurements to generate evolved neural metrics based on the neural metrics for the domain of interest, and generating the evolved neural metrics comprises generating a respective new version for one or more of the neural metrics for the domain of interest; and
outputting a ranking of the evolved neural metrics according to a respective quality of each of the evolved neural metrics, and the quality of one of the evolved neural metrics indicates an accuracy and reliability of that evolved neural metric in indicating a performance of the LLM with respect to questions from the domain of interest.

2. The method as recited in claim 1, wherein the LLM comprises a virtual assistant.

3. The method as recited in claim 1, wherein the fitness measurements are obtained using a fitness function that measures an adherence of a respective score computed by each of the neural metrics to a corresponding one of the human-generated scores.

4. The method as recited in claim 1, wherein the EA employs an iterative process to generate the evolved neural metrics.

5. The method as recited in claim 4, wherein the iterative process comprises operations performed with respect to the neural metrics and/or the new versions of the neural metrics, and the operations include selection, crossover, mutation, and replacement.

6. The method as recited in claim 1, wherein the new versions of the neural metrics are generated by applying one or more operators to the neural metrics.

7. The method as recited in claim 6, wherein the one or more operators comprise a crossover operator, and a mutation operator.

8. The method as recited in claim 1, wherein performance of the LLM is monitored continuously and one or more of the evolved neural metrics is updated when a change to the domain is detected.

9. The method as recited in claim 1, wherein each of the human-generated scores comprises either a ‘thumbs up’ vote or a ‘thumbs down’ vote.

10. The method as recited in claim 1, wherein one of the evolved neural metrics is an offspring of another evolved neural metric and/or of one of the neural metrics in the population of neural metrics.

11. A non-transitory storage medium having stored therein instructions that are executable by one or more hardware processors to perform operations comprising:
receiving, as input, a BoQ (basket of questions) from a domain of interest, LLM-generated answers to each of the questions, and a respective human-generated score for each of the LLM-generated answers;
obtaining respective fitness measurements, based on the input, for each neural metric in a population of neural metrics usable to evaluate a performance of the LLM when responding to a user inquiry;
using, by an EA (evolutionary algorithm), the fitness measurements to generate evolved neural metrics based on the neural metrics for the domain of interest, and generating the evolved neural metrics comprises generating a respective new version for one or more of the neural metrics for the domain of interest; and
outputting a ranking of the evolved neural metrics according to a respective quality of each of the evolved neural metrics, and the quality of one of the evolved neural metrics indicates an accuracy and reliability of that evolved neural metric in indicating a performance of the LLM with respect to questions from the domain of interest.

12. The non-transitory storage medium as recited in claim 11, wherein the LLM comprises a virtual assistant.

13. The non-transitory storage medium as recited in claim 11, wherein the fitness measurements are obtained using a fitness function that measures an adherence of a respective score computed by each of the neural metrics to a corresponding one of the human-generated scores.

14. The non-transitory storage medium as recited in claim 11, wherein the EA employs an iterative process to generate the evolved neural metrics.

15. The non-transitory storage medium as recited in claim 14, wherein the iterative process comprises operations performed with respect to the neural metrics and/or the new versions of the neural metrics, and the operations include selection, crossover, mutation, and replacement.

16. The non-transitory storage medium as recited in claim 11, wherein the new versions of the neural metrics are generated by applying one or more operators to the neural metrics.

17. The non-transitory storage medium as recited in claim 16, wherein the one or more operators comprise a crossover operator, and a mutation operator.

18. The non-transitory storage medium as recited in claim 11, wherein performance of the LLM is monitored continuously and one or more of the evolved neural metrics is updated when a change to the domain is detected.

19. The non-transitory storage medium as recited in claim 11, wherein each of the human-generated scores comprises either a ‘thumbs up’ vote or a ‘thumbs down’ vote.

20. The non-transitory storage medium as recited in claim 11, wherein one of the evolved neural metrics is an offspring of another evolved neural metric and/or of one of the neural metrics in the population of neural metrics.
